(19) United States
(12) Patent Application Publication
(10) Pub. No.: US 2009/0020421 A1
(43) Pub. Date: Jan. 22, 2009

(54) Voltage-Type Gas Concentration Sensor and Sensing Method

(75) Inventors: Shen-Kan Hsiung, Tao-Yuan (TW); Jung-Chuan Chou, Tao-Yuan (TW); Tai-Ping Sun, Tao-Yuan (TW); Nien-Hsuan Chou, Tao-Yuan (TW); Szu-Ping Chen, Tao-Yuan (TW); June-Jie Feng, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, Tao-Yuan (TW)

(21) Appl. No.: 11/778,673

(22) Filed: Jul. 17, 2007

(51) Int. Cl. G01N 27/407

(52) U.S. Cl. 204/406; 204/424

(57) ABSTRACT

This invention discloses a voltage-type gas concentration sensor and sensing method thereof. An ionic sensing electrode, a solid electrolyte membrane and a gas-permeable membrane are provided. The ionic sensing electrode comprises a sensing window. The solid electrolyte membrane is disposed on the sensing window. The gas-permeable membrane is disposed on the solid electrolyte membrane. By detecting the change of a reaction voltage as a result of reaction between the ionic sensing electrode and a solution to be measured, the invention is able to determine the pH of the solution to be measured.

### BACKGROUND OF THE INVENTION

1. Field of the Invention

The present invention generally relates to gas concentration sensors and sensing method thereof, especially a voltage-type gas concentration sensor and sensing method thereof.

2. Description of the Prior Art

Blood analyzers help patients monitor their own health conditions in a more cost-effective and convenient way before seeking a doctor for further diagnosis and treatment. Not only can patients monitor their health conditions by checking the densities of eight major parameters whenever they wish, but the information can also be provided to the doctors to facilitate diagnosis. When measuring the concentration of carbon dioxide, sensors that can provide stable and continuous measurements are needed. These sensors should be able quickly and accurately measure relevant data. Current methodologies for carbon dioxide analysis can be generally classified into three types: optical, current-type and voltage-type. Among these three types, voltage-type structures are usually simpler than the other two types of sensing structures. A voltage-type gas concentration sensor detects carbon dioxide concentration based on pH variation in its internal buffer solution.

Conventional pH ionic sensing electrodes for voltage-type gas concentration sensors are usually made of traditional pH glass electrodes, thus they have shortcomings, for example, they are large in volume, not easy to preserve and costly. Moreover, a bicarbonate solution needs regular replacement to avoid deterioration. In addition, a gas-permeable membrane at the outermost layer of the electrode is also consumable. Therefore, there is a need for an invention that is simple and cheap while eliminating the need for regular replacement of the internal buffer solution.

### SUMMARY OF THE INVENTION

In view of the prior art and the needs of the related industries, the present invention provides a voltage-type gas concentration sensor and sensing method that solves the abovementioned shortcomings of the conventional voltage-type gas concentration sensors and sensing methods.

One objective of the present invention is to provide a voltage-type gas concentration sensor that determines pH of solution to be measured by detecting the variation in reaction voltage of an ionic sensing electrode after reacting with the solution to be measured.

Another objective of the present invention is to provide a voltage-type gas concentration sensing method by providing an ionic sensing electrode having a sensing window, so as to allow gaseous ions in a solution to be measured to pass through a gas-permeable membrane and react with a solid electrolyte membrane disposed on the sensing window, causing ions to deionize, and detecting variation in reaction voltage as a result of deionized ions.

According to the above and other objectives, the present invention discloses a voltage-type gas concentration sensor, including an ionic sensing electrode including a sensing window, a solid electrolyte membrane and a gas-permeable membrane. The solid electrolyte membrane is disposed on the sensing window and the gas-permeable membrane disposed on the solid electrolyte membrane. The pH value of a solution to be measured can be determined by detecting variation in reaction voltage of the ionic sensing electrode after reacting with the solution to be measured.

According to the above and other objectives, the present invention discloses a voltage-type gas concentration sensing method by providing an ionic sensing electrode having a sensing window, so as to allow gaseous ions in a solution to be measured to pass through a gas-permeable membrane and react with a solid electrolyte membrane disposed on the sensing window, causing ions to deionize, and detecting variation in reaction voltage as a result of deionized ions.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a schematic diagram illustrating the structure of a voltage-type gas concentration sensor according to one embodiment of the present invention; and

FIG. 2 is a flow chart illustrating a voltage-type gas concentration sensing method according to one embodiment of the present invention.

### DETAILED DESCRIPTION OF THE PREFERRED EMBODIMENTS

The present invention is directed to a voltage-type gas concentration sensor and sensing method thereof. Detailed steps and constituents are given below to assist in the understanding the present invention. Obviously, the implementations of the present invention are not limited to the specific details known by those skilled in the art of voltage-type gas concentration sensor and sensing method thereof. On the other hand, well-known steps or constituents of digital watermarking are not described in details in order not to unnecessarily limit the present invention. Detailed embodiments of the present invention will be provided as follow. However, apart from these detailed descriptions, the present invention may be generally applied to other embodiments, and the scope of the present invention is thus limited only by the appended claims.

A first embodiment of the present invention is a voltage-type gas concentration sensor, including a ionic sensing electrode, a solid electrolyte membrane and a gas-permeable membrane. The ionic sensing electrode has a sensing window. The solid electrolyte membrane can be disposed on the sensing window, while the gas-permeable membrane can be disposed on the solid electrolyte membrane.

In this embodiment, the ionic sensing electrode can be preferably composed of the following materials, from outside to inside: zinc dioxide, carbon gel and poly vinyl chloride. In this embodiment, the solid electrolyte membrane can be preferably composed of one or a combination of the following materials: NaHCO₃, NaCl, deionized water (D.I. water), poly vinyl alcohol (PVA), and carbonic anhydrase. In this embodiment, the gas-permeable membrane can be preferably composed of one or a combination of the following materials: dioctyl sebacate (DOS), valinomycin, silicon rubber and tetrahydrofuran (THF) solution.

The voltage-type gas concentration sensor can include a reference electrode. The reference electrode outputs a constant reference voltage. The reference voltage serves as a reference for change in a reaction voltage measured by the voltage-type gas concentration sensor. The voltage-type gas concentration sensor can include a data processing device connected to the ionic sensing electrode and the reference electrode to detect the reaction voltage and the reference voltage thereof, respectively. The voltage-type gas concentration sensor can include a wireless transmission module electrically coupled to the ionic sensing electrode and the data processing device, such that the data processing device can wirelessly detect the variation in the reaction voltage of the ionic sensing electrode and the reference voltage of the reference electrode.

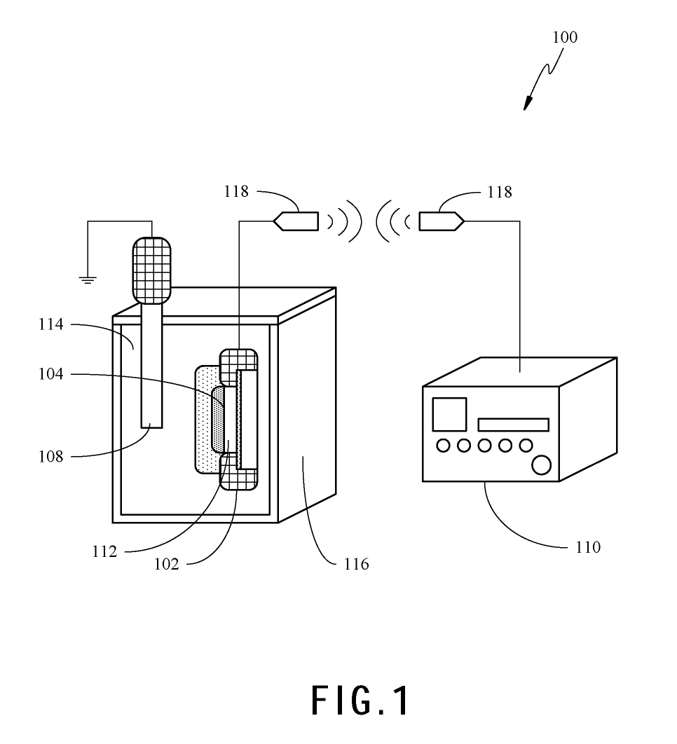

Referring to FIG. 1, in a preferred example of this embodiment, the voltage-type gas concentration sensor 100 includes an ionic sensing electrode 102, a solid electrolyte membrane 104, a gas-permeable membrane 106, a reference electrode 108 and a data processing device 110. The ionic sensing electrode 102 has a sensing window 112. The solid electrolyte membrane 104 can be disposed on the sensing window 112, while the gas-permeable membrane 106 can be disposed on the solid electrolyte membrane 104. The sensing window 112 on the ionic sensing electrode 102 can be placed inside a container 116 with a solution 114 to be measured, causing the ionic sensing electrode 102 to react with the solution 114 to create a reaction voltage.

The reference electrode 108 outputs a constant reference voltage. The reference voltage serves as a reference for measuring change in the reaction voltage of the ionic sensing electrode 102. The data processing device 110 can be connected to the ionic sensing electrode 102 and the reference electrode 108 to detect the reaction voltage and the reference voltage thereof, respectively. The voltage-type gas concentration sensor 100 can further include a wireless transmission module 118 electrically coupled to the ionic sensing electrode 102 and the data processing device 110, such that the data processing device 110 can wirelessly detect the variation in the reaction voltage of the ionic sensing electrode 102 and the reference voltage of the reference electrode 108. In this embodiment, the transmission protocol of wireless transmission module 118 can preferably be one or a combination of the following: WIFI, Bluetooth, ZigBee, WiMax, Wibree, UWB and infrared.

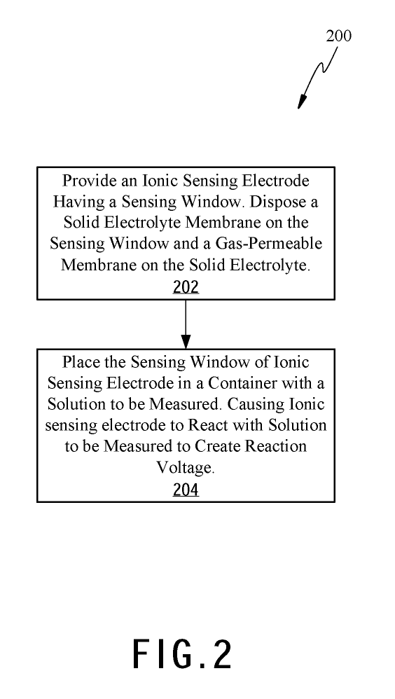

Referring to FIG. 2, a second embodiment of the present invention is a voltage-type gas concentration sensing method 200. First, as shown in step 202, an ionic sensing electrode is provided, wherein the ionic sensing electrode includes a sensing window, a solid electrolyte membrane on the sensing window and a gas-permeable membrane on the solid electrolyte. Second, as shown in step 204, placing the sensing window of the ionic sensing electrode in a container with a solution to be measured, causing the ionic sensing electrode to react with the solution to be measured to create a reaction voltage.

In this embodiment, the ionic sensing electrode can be preferably composed of the following materials, from outside to inside: zinc dioxide, carbon gel and poly vinyl chloride. In this embodiment, the solid electrolyte membrane can be preferably composed of one or a combination of the following materials: NaHCO₃, NaCl, deionized water (D.I. water), poly vinyl alcohol (PVA), and carbonic anhydrase. In this embodiment, the gas-permeable membrane can be preferably composed of one or a combination of the following materials: dioctyl sebacate (DOS), valinomycin, silicon rubber and tetrahydrofuran (THF) solution.

The voltage-type gas concentration sensing method can include a step of outputting a reference voltage by a reference electrode, which serves as a reference for change in a reaction voltage measured by the voltage-type gas concentration sensor. The method can further include a step of placing the ionic sensing electrode in a buffer solution and using a reaction voltage created after reaction between the ionic sensing electrode and the buffer solution is stable as a reference voltage.

The voltage-type gas concentration sensing method can include a data processing device connected to the ionic sensing electrode and the reference electrode to detect the reaction voltage and the reference voltage thereof, respectively. The voltage-type gas concentration sensing method can include a wireless transmission module electrically coupled to the ionic sensing electrode and the data processing device, such that the data processing device can wirelessly detect the variation in reaction voltage of the ionic sensing electrode and the reference voltage of the reference electrode. In this embodiment, the transmission protocol of wireless transmission module can preferably be one or a combination of the following: WIFI, Bluetooth, ZigBee, WiMax, Wibree, UWB and infrared.

### EXAMPLE 1

Preparation a voltage-type gas concentration sensor of the present invention requires the following steps of:

(1) Mix and stir 5 mM/l of NaHCO₃ and 0.5 mM/l of NaCl into deionized water and extract a suitable amount of solution from the mixture. Add a 4 wt % poly vinyl alcohol (PVA. Then, add 10 mg/ml of carbonic anhydrase. Stir the solution of PVA and carbonic anhydrase.

(2) Extract and dip 2.0 μl of the high-molecular solution in step (1) on the sensing window of the ionic sensing electrode.

(3) Leave the element in room temperature for 30 to 60 minutes to complete the preparation of solid electrolyte membrane.

(4) Dissolve 21.5 wt % dioctyl sebacate (DOS), 0.8 wt % valinomycin and 7.7 wt % silicon rubber in tetrahydrofuran (THF) solution (200 μl of THF is required for every 100 mg of silicon rubber).

(5) Extract and dip 5.0 μl of the mixture in step (4) on the sensing window covered by the solid electrolyte membrane and leave the element under room temperature overnight.

(6) Upon forming the gas-permeable membrane, the preparation of the voltage-type gas concentration sensor is completed.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A voltage-type gas concentration sensor, including:
an ionic sensing electrode including a sensing window;
a solid electrolyte membrane disposed on the sensing window; and
a gas-permeable membrane disposed on the solid electrolyte membrane.

2. A voltage-type gas concentration sensor of claim 1, wherein the ionic sensing electrode includes, from outside to inside, zinc dioxide, carbon gel and poly vinyl chloride.

3. A voltage-type gas concentration sensor of claim 1, wherein the solid electrolyte membrane includes one selected from the group consisting of NaHCO₃, NaCl, deionized water, poly vinyl alcohol (PVA), carbonic anhydrase and a combination thereof.

4. A voltage-type gas concentration sensor of claim 1, wherein the gas-permeable membrane includes one selected from the group consisting of dioctyl sebacate (DOS), valinomycin, silicon rubber, tetrahydrofuran (THF) solution and a combination thereof.

5. A voltage-type gas concentration sensor of claim 1, wherein the voltage-type gas concentration sensor further includes a reference electrode for outputting a constant reference voltage, which serves as a reference for change in a reaction voltage measured by the voltage-type gas concentration sensor.

6. A voltage-type gas concentration sensor of claim 5, wherein the voltage-type gas concentration sensor further includes a data processing device connected to the ionic sensing electrode and the reference electrode to detect the reaction voltage and the reference voltage thereof, respectively.

7. A voltage-type gas concentration sensor of claim 6, wherein the voltage-type gas concentration sensor further includes a wireless transmission module electrically coupled to the ionic sensing electrode and the data processing device, such that the data processing device can wirelessly detect the variation in the reaction voltage of the ionic sensing electrode and the reference voltage of the reference electrode.

8. A voltage-type gas concentration sensor of claim 7, wherein a transmission protocol of the wireless transmission module is one selected from the group consisting of WIFI, Bluetooth, ZigBee, WiMax, Wibree, UWB, infrared and a combination thereof.

9. A voltage-type gas concentration sensing method, including the steps of:
providing an ionic sensing electrode, wherein the ionic sensing electrode includes:
a sensing window;
a solid electrolyte membrane on the sensing window; and
a gas-permeable membrane on the solid electrolyte membrane; and
placing the sensing window on the ionic sensing electrode in a container with a solution to be measured, causing the ionic sensing electrode to react with the solution to create a reaction voltage.

10. A voltage-type gas concentration sensing method of claim 9, wherein the ionic sensing electrode includes, from outside to inside, zinc dioxide, carbon gel and poly vinyl chloride.

11. A voltage-type gas concentration sensing method of claim 9, wherein the solid electrolyte membrane includes one selected from the group consisting of NaHCO₃, NaCl, deionized water, poly vinyl alcohol (PVA), carbonic anhydrase and a combination thereof.

12. A voltage-type gas concentration sensing method of claim 9, wherein the gas-permeable membrane includes one selected from the group consisting of dioctyl sebacate (DOS), valinomycin, silicon rubber, tetrahydrofuran (THF) solution and a combination thereof.

13. A voltage-type gas concentration sensing method of claim 9, further including a step of outputting a reference voltage, which serves as a reference for change in the reaction voltage measured by the voltage-type gas concentration sensor.

14. A voltage-type gas concentration sensing method of claim 9, further including a step of placing the ionic sensing electrode in a buffer solution and using a reaction voltage created after reaction between the ionic sensing electrode and the buffer solution becomes stable as a reference voltage.

15. A voltage-type gas concentration sensing method of claim 13, further including a data processing device connected to the ionic sensing electrode and the reference electrode to detect the reaction voltage and the reference voltage thereof, respectively.

16. A voltage-type gas concentration sensing method of claim 15, further including a wireless transmission module electrically coupled to the ionic sensing electrode and the data processing device, such that the data processing device can wirelessly detect the variation in the reaction voltage of the ionic sensing electrode and the reference voltage of the reference electrode.

17. A voltage-type gas concentration sensing method of claim 16, wherein a transmission protocol of the wireless transmission module is one selected from the group consisting of WIFI, Bluetooth, ZigBee, WiMax, Wibree, UWB, infrared and a combination thereof.

18. A voltage-type gas concentration sensor, including:
an ionic sensing electrode including a sensing window;
a solid electrolyte membrane disposed on the sensing window;
a gas-permeable membrane disposed on the solid electrolyte membrane;
a reference electrode for outputting a constant reference voltage, wherein the reference voltage serves as a reference for change in a reaction voltage of the ionic sensing electrode; and
a data processing device connected to the ionic sensing electrode and the reference electrode to detect the reaction voltage and the reference voltage thereof, respectively.

19. A voltage-type gas concentration sensor of claim 18, wherein the voltage-type gas concentration sensor further includes a wireless transmission module electrically coupled to the ionic sensing electrode and the data processing device, such that the data processing device can wirelessly detect the variation in the reaction voltage of the ionic sensing electrode and the reference voltage of the reference electrode.

20. A voltage-type gas concentration sensor of claim 19, wherein a transmission protocol of the wireless transmission module is one selected from the group consisting of WIFI, Bluetooth, ZigBee, WiMax, Wibree, UWB, infrared and a combination thereof.
